(19) United States
(12) Patent Application Publication
(10) Pub. No.: US 2026/0179833 A1
(43) Pub. Date: Jun. 25, 2026

(54) METALLIZED FERRITE PLANAR TRANSFORMER

(71) Applicant: Tesla, Inc., Austin, TX (US)

(72) Inventors: Geoff Goodwin-Wilson, San Francisco, CA (US); Bradley Anthony Haas, Palo Alto, CA (US); Sara Davidova, Palo Alto, CA (US)

(21) Appl. No.: 19/425,203

(22) Filed: Dec. 18, 2025

Related U.S. Application Data
(60) Provisional application No. 63/737,073, filed on Dec. 20, 2024.

(51) Int. Cl. H01F 38/14; H01F 1/153; H01F 1/34; H01F 3/14; H01F 27/28; H01F 41/04

(52) U.S. Cl. CPC H01F 38/14; H01F 1/153; H01F 1/344; H01F 3/14; H01F 27/2804; H01F 41/041; H01F 2027/2819

(57) ABSTRACT

A magnetic component assembly includes a first ferrite body having a first surface and a first metallized layer comprising silver and glass frit disposed on the first surface. A printed circuit board includes a coil pattern, and a second ferrite body having a second surface with a second metallized layer is provided. The first ferrite body is disposed on a first side of the printed circuit board and the second ferrite body is disposed on a second side, with the metallized layers coupled to the coil pattern to enable power transfer between windings.

### CLAIM FOR PRIORITY

This application claims the benefit of priority of U.S. Provisional Application No. 63/737,073, filed Dec. 20, 2024, which is incorporated by reference in its entirety.

### TECHNICAL FIELD

The present disclosure generally relates to magnetic components and power electronics. More specifically, the disclosure relates to transformers, magnetic components in printed circuit board assemblies, and methods of manufacturing electronic components. The field includes power conversion systems, isolation transformers, and surface mount technology for electronic assemblies. This disclosure further relates to manufacturing processes for electronic components, particularly in the field of power electronics and circuit board assembly techniques.

### BACKGROUND

Power electronics and electronic assemblies commonly require magnetic components for power conversion and signal isolation. Traditional planar transformer designs typically require cutting holes or creating cutouts through the printed circuit board (PCB) to accommodate ferrite cores. These conventional approaches present significant manufacturing and design challenges that impact both cost and performance.

Current methods for integrating ferrite cores with planar transformers involve complex assembly processes requiring precise air gap control between ferrite halves. For example traditional approaches may utilize glass beads mixed with adhesives to maintain proper spacing, creating manufacturing complexities including adhesive storage requirements, curing processes, and precise application pattern development. The requirement for PCB cutouts or holes introduces additional challenges related to creepage and clearance requirements, as circuit nodes at different voltages must maintain proper spacing around these openings.

These traditional manufacturing methods also present air gap control difficulties, where the tiny air gaps between ferrite halves must be precisely maintained. Such approaches add manufacturing steps, increase production cycle time, and can introduce variability in electrical performance between manufactured units. Additionally, the holes or cutouts required in traditional designs can complicate board layout and limit design flexibility.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram depicting a ferrite disc component with a metallized layer of a planar transformer assembly, according to certain examples.

FIG. 2 is a diagram depicting a coil pattern of a printed circuit board that forms the transformer windings in a planar transformer assembly, according to certain examples.

FIG. 3 is a diagram depicting a transformer assembly, according to certain examples.

FIG. 4 depicts ferrite disc components of the transformer assembly, showing the magnetic field coupling and flux path configuration that enables power transfer between the primary and secondary windings in the planar transformer design, according to certain examples

FIG. 5 is a flow chart illustrating a method for manufacturing a metallized ferrite component, according to certain examples.

### DETAILED DESCRIPTION

Modern power electronics increasingly rely on planar magnetic components integrated into printed circuit board (PCB) assemblies for power conversion and signal isolation. Traditional methods of incorporating magnetic components, particularly transformers with ferrite cores, into PCB assemblies typically require cutting holes or creating cutouts through the printed circuit board to accommodate ferrite components. These conventional approaches present significant manufacturing and design challenges, including complex air gap control between ferrite halves using glass beads mixed with adhesives, precise application pattern development, and increased production cycle times. Additionally, the requirement for PCB cutouts introduces complications related to creepage and clearance requirements, as circuit nodes at different voltages must maintain proper spacing around these openings.

The present disclosure seeks to provide solutions to these manufacturing and design challenges through a magnetic component assembly that integrates metallization layers with ferrite components positioned on opposite sides of a printed circuit board. In certain examples, the assembly comprises a first ferrite body having a metallized surface on a first side of a printed circuit board and a second ferrite body having a metallized surface on a second side of the printed circuit board, with coil patterns disposed between them. This approach eliminates the need for PCB holes or cutouts while using the entire board thickness as the air gap, significantly simplifying manufacturing and improving design flexibility.

The terms “first” and “second” as used throughout this disclosure and in the claims are employed solely as identifiers to distinguish between similar elements and components. These ordinal designations do not imply any sequential order, temporal relationship, priority, or hierarchy between the identified elements. For example, references to a “first ferrite disc” and a “second ferrite disc” are used merely to differentiate between two separate ferrite disc components within the assembly, without suggesting that one must be provided, manufactured, or positioned before the other. Similarly, references to a “first surface,” “second surface,” “first metallized layer,” “second metallized layer,” and analogous ordinal identifiers serve only to clarify which specific component or feature is being referenced in the context of the disclosure and claims. These terms are interchangeable labels that could be substituted with other distinguishing identifiers without affecting the scope or meaning of the invention.

In some examples, the ferrite bodies comprise disc-shaped structures with diameters which may be configured per application. The ferrite material may comprise Siferrit or equivalent magnetic materials suitable for power electronics applications. The metallized layers may in some examples comprise silver combined with glass frit material, with thicknesses sufficient to ensure proper electrical and mechanical characteristics. The metallization serves a dual purpose: providing mechanical attachment to the PCB and creating electrical pathways for current flow.

In some examples, the metallization process includes ultrasonic washing of the ferrite surfaces followed by screen printing of the silver and glass frit material. Accordingly, the metallized surfaces may provide both mechanical attachment points and electrical conductivity, creating current paths from a central node of the coil patterns to complete the circuit. In certain examples, the attachment to the PCB may be accomplished through various methods including conductive adhesive bonding, solder joints, or other suitable bonding techniques that maintain both mechanical integrity and electrical continuity.

In some examples, the assembly provides electrical isolation capabilities suitable for high-voltage applications, including power supplies in automotive and industrial applications with elevated battery or system voltages. The elimination of PCB holes or cutouts provides significant advantages including improved creepage and clearance characteristics, easier air gap control, and reduced manufacturing complexity compared to traditional hole-through-board designs. Additionally, the ferrite components provide electromagnetic interference (EMI) shielding benefits while enabling operation at lower frequencies and achieving higher coupling coefficients compared to air core transformer designs.

In some examples, the metallized surfaces may incorporate additional spiral patterns to increase inductance and improve transformer quality. For example, on top of having spirals on the PCB board, the metallization layer can include additional spiral patterns that the current traverses when escaping from the center of the coil. These additional spirals in the metallization layer increase the inductance, which can improve the overall quality and performance of the transformer while providing an integrated solution that eliminates the need for separate jumper traces or via connections.

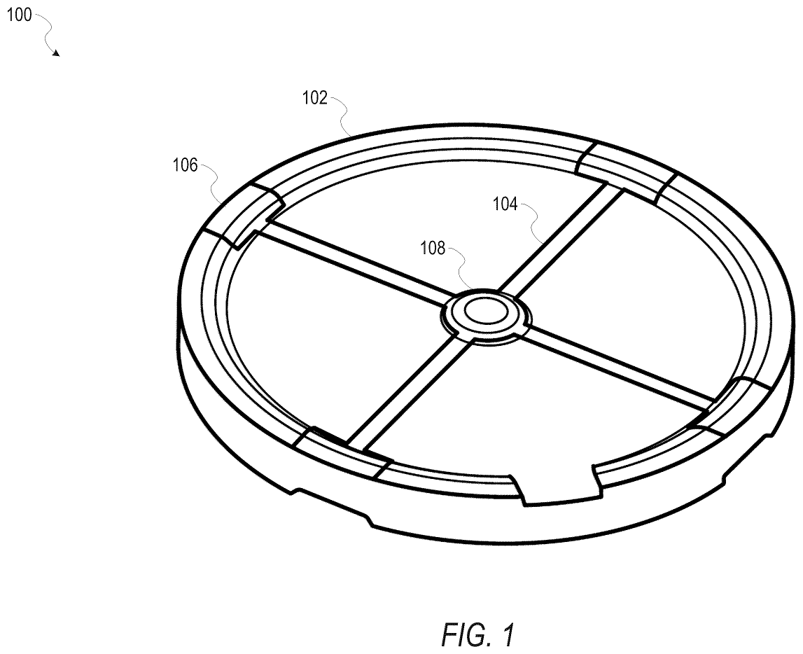

FIG. 1 is a diagram depicting a ferrite disc component 100 with a metallized layer 104, according to certain examples. A ferrite disc 102 forms the structure of the component, comprising a disc-shaped ferrite body which may be constructed from Siferrit or equivalent magnetic material specifically selected for power electronics applications, with the disc exhibiting dimensional tolerances and geometric specifications.

In some examples, the metallized layer 104 comprises a conductive metallization applied to predetermined surface areas of the ferrite disc 102. For example, the metallized layer 104 may be applied by a metallization process that may include ultrasonic washing of the ferrite disc 102 followed by an application process that may include screen printing of silver combined with glass frit material to achieve thickness specifications for both electrical conductivity and mechanical integrity. Accordingly, the metallized layer 104 provides mechanical attachment capabilities to printed circuit boards while simultaneously establishing electrical conductivity pathways that replace traditional jumper traces or via connections.

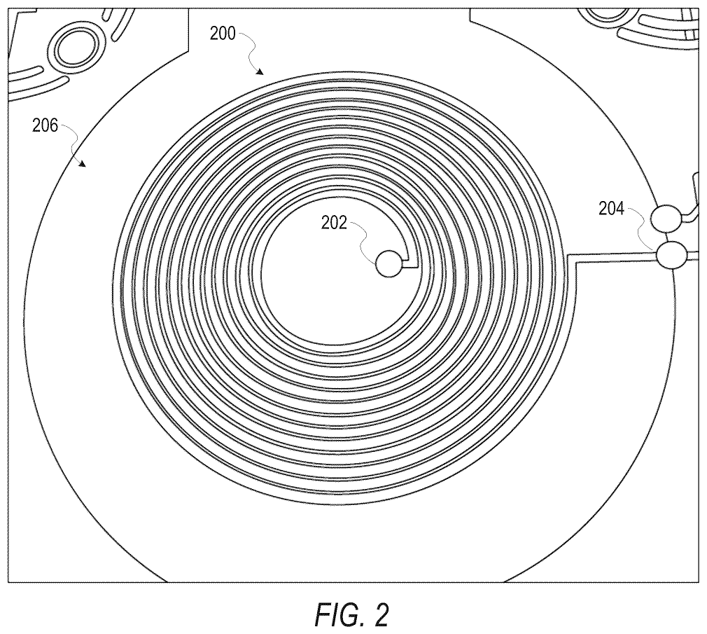

In some examples, a central contact node 108 comprises an electrical connection point located within a central region of the ferrite disc 102 and the metallized layer 104, to interface directly with a central point of a spiral coil pattern printed on the PCB substrate (as depicted in FIG. 2), where electrical current enters or exits the metallized conduction pathway to complete transformer circuit functionality. In some examples, the central contact node 108 works in conjunction with a perimeter contact 106, which represents one of multiple outer electrical connection points distributed around the periphery of the metallized layer 104 upon the ferrite disc 102, to facilitate current flow distribution and collection across the metallized layer 104, and creating an electrical pathway that eliminates the need for separate bus bars, jumper wires, or complex via structures traditionally found in planar transformer designs.

FIG. 2 is a diagram depicting a coil pattern 200 of a printed circuit board that forms the transformer windings in a planar transformer assembly, according to certain examples. The coil pattern 200 comprises a spiral coil pattern printed on a PCB substrate 206, creating an electrical pathway for current flow in the transformer circuit.

In some examples, a central contact 202 provides an electrical connection point located within a central region of the coil pattern 200, where current enters or exits the spiral winding pattern. The central contact 202 may interface directly with the central contact 108 of the metallized ferrite disc component 100.

In some examples, a peripheral contact 204 provides an electrical connection point of the coil pattern 200 and may be positioned at the periphery of the spiral winding structure of the coil pattern 200. The peripheral contact 204 may work in conjunction with the central contact 202 to complete the electrical circuit through the spiral winding pattern.

In some examples, the coil pattern 200 represents one half of the planar transformer assembly, and may be positioned between two metallized ferrite discs, on the top and bottom sides of the PCB substrate 206.

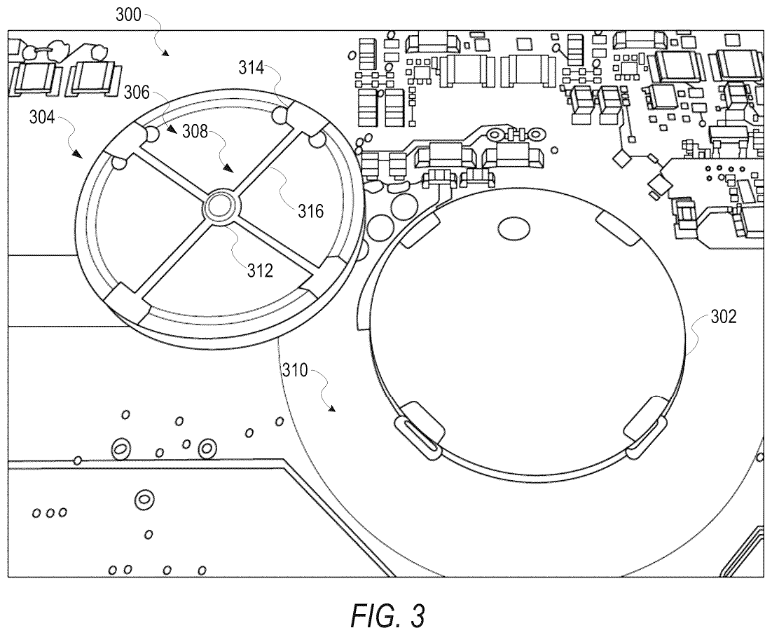

FIG. 3 is a diagram depicting a planar transformer assembly 300, according to certain examples. As seen in FIG. 3, the ferrite disc component 302 is adhered to the PCB 310. The transformer assembly 300 represents a fully assembled system where metallized ferrite discs are positioned on opposite sides of the PCB 310 to create the planar transformer assembly 300.

The ferrite disc component 302 shown in the assembly demonstrates one of the ferrite bodies with its metallized surface positioned to interface directly with the coil patterns (depicted in FIG. 2) printed on the PCB 310 substrate. As discussed herein, the ferrite disc component 302 provides mechanical attachment to the PCB and electrical conductivity for current flow through the transformer circuit.

A supplemental depiction 304 provides an additional view showing the underside 306 of the ferrite disc component 302. The underside 306 shows the metallized layer 308. This metallized layer 308 creates an electrical pathway that replace traditional jumper traces or via connections, enabling current to flow from the center of the coil patterns through the metallized surface. The metallized layer 308 is depicted in a cruciform, or saltire configuration, it should be noted that there are other embodiments possible, and that the structure generally comprises a central connection point (i.e., contact 312) to interface with a central connection point of the coil printed on the PCB 310, and a peripheral connection point (i.e., contact 314) to interface with a peripheral connection of the coil on the PCB 310, and wherein the central connection point and peripheral connection point are connected via a bridge 316.

According to certain examples, the ferrite disc component 302 is bonded or adhered to the PCB 310 via the metallized layer 308 using various attachment methods that provide electrical conductivity. For example, the bonding process can include a conductive adhesive, as well as solder joint attachment.

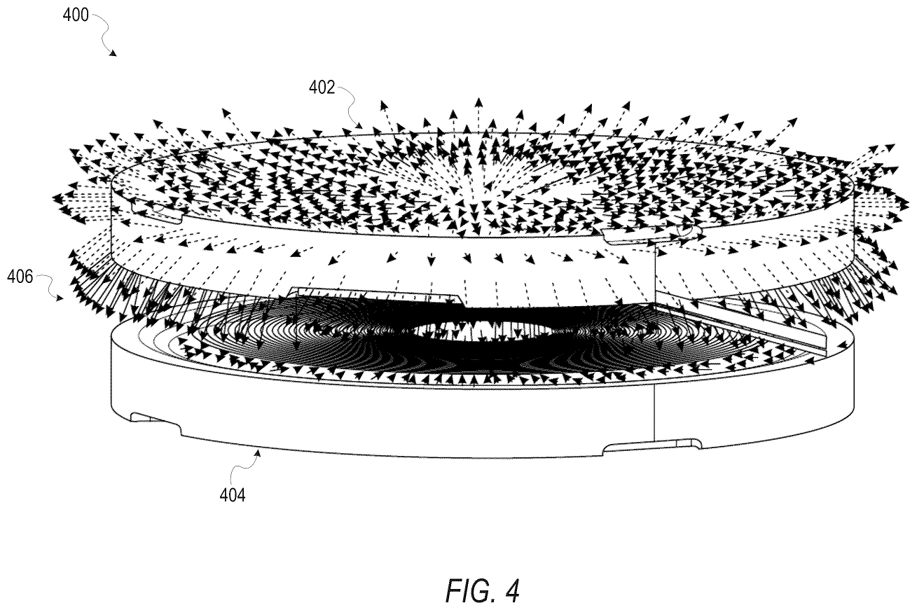

FIG. 4 depicts ferrite disc components 400 of the transformer assembly, showing the magnetic field coupling and flux path configuration that enables power transfer between the primary and secondary windings in the planar transformer design, according to certain examples.

The first ferrite disc 402 represents one half of the magnetic circuit, positioned on a first side of the printed circuit board (e.g., a top side—not shown for illustrative purposes). The ferrite disc 402 contains the metallized layer that interfaces with the coil patterns printed on the PCB surface, serving both mechanical attachment and electrical conductivity functions as described herein.

A second ferrite disc 404 represents the complementary ferrite component positioned on the opposite side of the PCB, completing the magnetic circuit. Like the first ferrite disc 402, this second ferrite disc 404 also features metallized surfaces that bond to the coil patterns on its respective PCB side (e.g., the bottom side).

An air gap 406 represents the spacing between the first ferrite disc 402 and second ferrite disc 404, which corresponds to the complete thickness of the PCB. Accordingly, the disclosed approach uses the whole board as the air gap, eliminating the need for precise air gap control using glass beads and adhesives that are required in traditional hole-through-board designs. The fields shown in FIG. 4 represent magnetic flux lines that demonstrate how magnetic energy couples between the first ferrite disc 402 and second ferrite disc 404 across the air gap 406.

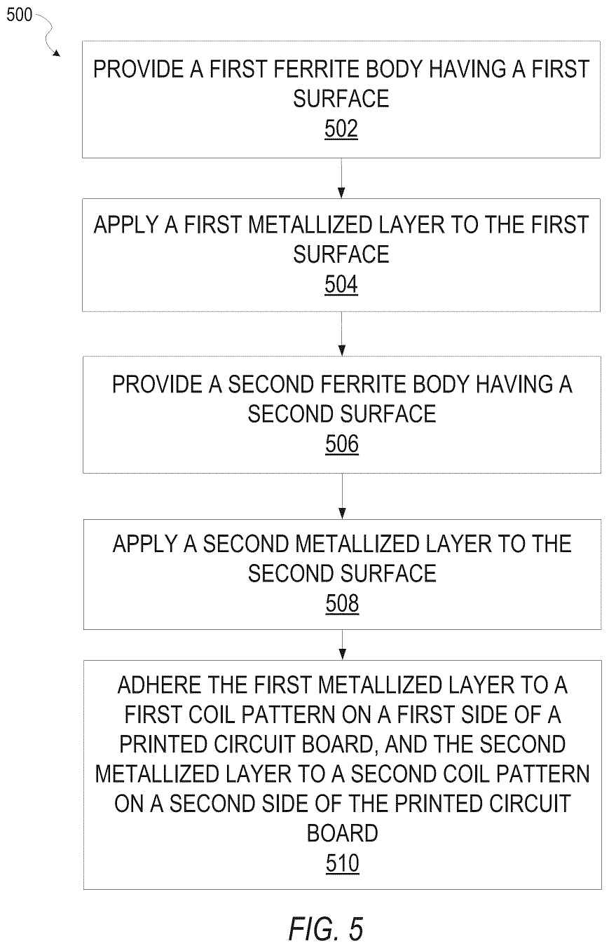

FIG. 5 is a flow chart illustrating a method 500 for manufacturing a metallized ferrite component, according to certain examples.

At operation 502, the method 500 begins by providing a first ferrite body having a first surface. According to certain examples, this first ferrite body comprises a disc-shaped structure constructed from Siferrit or equivalent magnetic materials specifically selected for power electronics applications.

At operation 504, a first metallized layer is applied to the first surface of the first ferrite body. In some examples, this metallization process may include ultrasonic washing of the ferrite surfaces to ensure proper surface preparation, followed by screen printing of silver combined with glass frit material to achieve the required thickness specifications for both electrical conductivity and mechanical integrity. In some examples, the metallized layers may incorporate additional spiral patterns to increase inductance and improve transformer quality, where the metallization layer can include spiral patterns that current traverses when escaping from the center of the coil, thereby increasing inductance and improving overall transformer performance.

At operation 506, a second ferrite body having a second surface is provided, which represents the complementary ferrite component that will be positioned on the opposite side of the printed circuit board to complete the magnetic circuit. This second ferrite body may be constructed from the same magnetic materials as the first ferrite body and in some examples may exhibit the same dimensional specifications.

At operation 508, a second metallized layer is applied to the second surface of the second ferrite body using the same metallization process described in operation 504. As discussed above, this may include ultrasonic washing followed by screen printing of the silver and glass frit material.

At operation 510, the first metallized layer of the first ferrite body is adhered to a first coil pattern on a first side of a printed circuit board, and the second metallized layer is adhered to a second coil pattern on a second side of the printed circuit board. In some examples, the adherence is accomplished through conductive adhesive bonding, where conductive glue is applied between the metallized surfaces and the corresponding coil patterns, providing both mechanical attachment and electrical pathways. In some examples, a solder joint attachment may be used.

### EXAMPLES

Example 1 is a magnetic component assembly comprising a first ferrite body comprising a first surface, a first metallized layer on the first surface of the first ferrite body, a printed circuit board having a coil pattern, a second ferrite body having a second surface, and a second metallized layer on the second surface of the second ferrite body.

Example 2 includes the subject matter of Example 1, wherein the first ferrite body is disposed on a first side of the printed circuit board, and the second ferrite body is disposed on a second side of the printed circuit board.

Example 3 includes the subject matter of Examples 1-2, wherein the coil pattern comprises a first coil pattern printed upon the first surface of the PCB and a second coil pattern printed upon the second surface of the PCB, and the first and second metallized layers are coupled to the first coil pattern and the second coil pattern of the printed circuit board through a first solder joint and a second solder joint.

Example 4 includes the subject matter of Examples 1-2, wherein the coil pattern comprises a first coil pattern printed upon the first surface of the PCB and a second coil pattern printed upon the second surface of the PCB, and the first and second metallized layers are coupled to the first coil pattern and the second coil pattern of the printed circuit board through a conductive adhesive.

Example 5 includes the subject matter of Examples 1-4, wherein the metallized layer comprises a silver and glass frit.

Example 6 includes the subject matter of Examples 1-5, wherein an air gap is disposed between the first ferrite body and the second ferrite body, the air gap comprising an air gap thickness that corresponds to a PCB thickness of the PCB.

Example 7 includes the subject matter of Examples 1-6, wherein the metallized layer comprises a screen-printed layer.

Example 8 includes the subject matter of Examples 1-7, wherein the first ferrite body comprises an ultrasonically washed surface adjacent to the metallized layer.

Example 9 includes the subject matter of Examples 1-8, wherein the first metallized layer and second metallized layer comprise a cruciform pattern disposed upon the first ferrite body and the second ferrite body.

Example 10 includes the subject matter of Examples 1-9, wherein the first metallized layer and second metallized layer each comprise a central contact disposed upon a central portion of the first surface of the first ferrite body and the second surface of the second ferrite body, the central contact interfacing with a central connection point of the coil pattern, to peripheral contacts printed upon the first surface of the first ferrite body and the second surface of the second ferrite body, the peripheral contacts interfacing with a peripheral connection point of the coil pattern.

Example 11 is a method of manufacturing a magnetic component assembly comprising providing a first ferrite body having a first surface, applying a first metallized layer to the first surface, providing a second ferrite body having a second surface, applying a second metallized layer to the second surface, and adhering the first metallized layer to a first coil pattern on a first side of a printed circuit board and the second metallized layer to a second coil pattern on a second side of the PCB.

Example 12 includes the subject matter of Example 11, wherein applying the metallized layer comprises screen printing.

Example 13 includes the subject matter of Examples 11-12, further comprising ultrasonically washing the first surface before applying the metallized layer.

Example 14 includes the subject matter of Examples 11-13, wherein the metallized layer comprises a silver and glass frit.

Example 15 includes the subject matter of Examples 11-14, further comprising an air gap disposed between the first ferrite body and the second ferrite body, the air gap comprising an air gap thickness that corresponds to a PCB thickness of the PCB.

Example 16 is a transformer assembly comprising a first ferrite body comprising a first surface, a first metallized layer on the first surface of the first ferrite body, a printed circuit board having a coil pattern, a second ferrite body having a second surface, and a second metallized layer on the second surface of the second ferrite body.

Example 17 includes the subject matter of Example 16, wherein the metallized layer comprises a silver and glass frit.

Example 18 includes the subject matter of Examples 16-17, wherein the coil pattern comprises a first coil pattern printed upon the first surface of the PCB and a second coil pattern printed upon the second surface of the PCB, and the first and second metallized layers are coupled to the first coil pattern and the second coil pattern of the printed circuit board through a conductive adhesive.

Example 19 includes the subject matter of Examples 16-18, further comprising an air gap disposed between the first ferrite body and the second ferrite body, the air gap comprising an air gap thickness that corresponds to a PCB thickness of the PCB.

Example 20 includes the subject matter of Examples 16-19, wherein the first metallized layer and second metallized layer comprise a cruciform pattern disposed upon the first ferrite body and the second ferrite body.

Example 21 may include an apparatus comprising means to perform one or more elements of a method described in or related to any of the preceding examples or any other method or process described herein.

Example 23 may include an apparatus comprising logic, modules, or circuitry to perform one or more elements of a method described in or related to any of the preceding examples or any other method or process described herein.

Example 24 may include a method, technique, or process as described in or related to any of the preceding examples or portions or parts thereof.

Example 25 may include an apparatus comprising one or more processors and one or more computer-readable media comprising instructions that, when executed by the one or more processors, cause the one or more processors to perform the method, techniques, or process as described in or related to any of the preceding examples, or portions thereof.

What is claimed is:

1. A magnetic component assembly comprising:
a first ferrite body comprising a first surface;
a first metallized layer on the first surface of the first ferrite body;
a printed circuit board (PCB) having a coil pattern;
a second ferrite body having a second surface; and
a second metallized layer on the second surface of the second ferrite body.

2. The magnetic component assembly of claim 1, wherein the first ferrite body is disposed on a first side of the printed circuit board, and the second ferrite body is disposed on a second side of the printed circuit board.

3. The magnetic component assembly of claim 1, wherein the coil pattern comprises a first coil pattern printed upon the first surface of the PCB and a second coil pattern printed upon the second surface of the PCB, and the first and second metallized layers are coupled to the first coil pattern and the second coil pattern of the printed circuit board through a first solder joint and a second solder joint.

4. The magnetic component assembly of claim 1, wherein the coil pattern comprises a first coil pattern printed upon the first surface of the PCB and a second coil pattern printed upon the second surface of the PCB, and the first and second metallized layers are coupled to the first coil pattern and the second coil pattern of the printed circuit board through a conductive adhesive.

5. The magnetic component assembly of claim 1, wherein the metallized layer comprises a silver and glass frit.

6. The magnetic component assembly of claim 1, further comprising an air gap disposed between the first ferrite body and the second ferrite body, the air gap comprising an air gap thickness that corresponds to a PCB thickness of the PCB.

7. The magnetic component assembly of claim 1, wherein the metallized layer comprises a screen-printed layer.

8. The magnetic component assembly of claim 1, wherein the first ferrite body comprises an ultrasonically washed surface adjacent to the metallized layer.

9. The magnetic component assembly of claim 1, wherein the first metallized layer and second metallized later comprise a cruciform pattern disposed upon the first ferrite body and the second ferrite body.

10. The magnetic component assembly of claim 1, wherein the first metallized layer and second metallized layer each comprise a central contact disposed upon a central portion of the first surface of the first ferrite body and the second surface of the second ferrite body, the central contact interfacing with a central connection point of the coil pattern, to peripheral contacts printed upon the first surface of the first ferrite body and the second surface of the second ferrite body, the peripheral contacts interfacing with a peripheral connection point of the coil pattern.

11. A method of manufacturing a magnetic component assembly comprising:
providing a first ferrite body having a first surface;
applying a first metallized layer to the first surface;
providing a second ferrite body having a second surface;
applying a second metallized layer to the second surface; and
adhering the first metallized layer to a first coil pattern on a first side of a printed circuit board (PCB), and the second metallized layer to a second coil pattern on a second side of the PCB.

12. The method of claim 10, wherein applying the metallized layer comprises screen printing.

13. The method of claim 10, further comprising ultrasonically washing the first surface before applying the metallized layer.

14. The method of claim 10, wherein the metallized layer comprises a silver and glass frit.

15. The method of claim 10, further comprising an air gap disposed between the first ferrite body and the second ferrite body, the air gap comprising an air gap thickness that corresponds to a PCB thickness of the PCB.

16. A transformer assembly comprising:
a first ferrite body comprising a first surface;
a first metallized layer on the first surface of the first ferrite body;
a printed circuit board (PCB) having a coil pattern;
a second ferrite body having a second surface; and
a second metallized layer on the second surface of the second ferrite body.

17. The transformer assembly of claim 16, wherein the metallized layer comprises a silver and glass frit.

18. The transformer assembly of claim 16, wherein the coil pattern comprises a first coil pattern printed upon the first surface of the PCB and a second coil pattern printed upon the second surface of the PCB, and the first and second metallized layers are coupled to the first coil pattern and the second coil pattern of the printed circuit board through a conductive adhesive.

19. The transformer assembly of claim 16, further comprising an air gap disposed between the first ferrite body and the second ferrite body, the air gap comprising an air gap thickness that corresponds to a PCB thickness of the PCB.

20. The transformer assembly of claim 16, wherein the first metallized layer and second metallized later comprise a cruciform pattern disposed upon the first ferrite body and the second ferrite body.
